(19) United States
(12) Patent Application Publication
(10) Pub. No.: US 2014/0201047 A1
(43) Pub. Date: Jul. 17, 2014

(54) DETERMINING A PAYMENT POLICY

(71) Applicant: International Business Machines Corporation, Armonk, NY (US)

(72) Inventors: Ashish Jagmohan, Irvington, NY (US); Anshul Sheopuri, White Plains, NY (US)

(73) Assignee: International Business Machines Corporation, Armonk, NY (US)

(21) Appl. No.: 13/974,592

(22) Filed: Aug. 23, 2013

Related U.S. Application Data
(63) Continuation of application No. 13/742,332, filed on Jan. 15, 2013.

(51) Int. Cl. G06Q 40/02

(52) U.S. Cl. CPC G06Q 40/02
USPC 705/35

(57) ABSTRACT

A method of generating a recommendation reducing a cost of subject attrition includes generating a plurality of policies, wherein each of the plurality of policies models a dependence of an attrition risk of each of a plurality of subject categories on a plurality of payment components of the plurality of subject categories, and each of the plurality of policies is associated with a respective set of weights on the plurality of subject categories, determining a benefit of each of the plurality of policies, selecting a selected policy from among the plurality of policies according to the benefit, and generating a recommendation for adjusting a specific payment component of a specific subject for each policy according to the selected policy.

### BACKGROUND

Cross-reference to Related Application(s): This application is a continuation of U.S. patent application Ser. No. 13/742,332 filed 15 Jan. 2013. The complete disclosure of U.S. patent application Ser. No. 13/742,332 is expressly incorporated herein by reference in its entirety for all purposes.

This disclosure relates to payment policies, and more particularly, to a method for determining a payment policy.

Customer retention is an important aspect of many businesses. Various methods exist for reducing customer attrition through tailored retention policies.

### BRIEF SUMMARY

According to an embodiment of the present disclosure, a method of generating a recommendation reducing a cost of subject attrition includes generating a plurality of policies, wherein each of the plurality of policies models a dependence of an attrition risk of each of a plurality of subject categories on a plurality of payment components of the plurality of subject categories, and each of the plurality of policies is associated with a respective set of weights on the plurality of subject categories, determining a benefit of each of the plurality of policies, selecting a selected policy from among the plurality of policies according to the benefit, and generating a recommendation for adjusting a specific payment component of a specific subject for each policy according to the selected policy.

According to an embodiment of the present disclosure, a payment policy recommendation system includes a memory device storing a plurality of instructions embodying the payment policy recommendation system and historic data, and a processor configured to receive the historic data and execute the plurality of instructions to perform a method, wherein the method includes generating a plurality of policies, wherein each of the plurality of policies models a dependence of an attrition risk of each of a plurality of subject categories on a plurality of payment components of the plurality of subject categories, wherein each of the plurality of policies is associated with a respective set of weights on the plurality of subject categories, determining a benefit of each of the plurality of policies, selecting a selected policy from among the plurality of policies according to the benefit, and generating a recommendation for adjusting a specific payment component of a specific subject for each policy according to the selected policy.

### BRIEF DESCRIPTION OF THE SEVERAL VIEWS OF THE DRAWINGS

Preferred embodiments of the present disclosure will be described below in more detail, with reference to the accompanying drawings:

FIG. 1 is flow diagram of an illustrative method for recommending a payment policy according to an embodiment of the present disclosure;

FIG. 2 is a flow diagram of an attrition modeler according to an embodiment of the present disclosure;

FIG. 3 is a flow diagram of a manager modeler according to an embodiment of the present disclosure;

FIG. 4 is a flow diagram of a replacement cost modeler according to an embodiment of the present disclosure; and

FIG. 5 is a block diagram depicting an exemplary computer system for performing a method for recommending a payment policy according to an embodiment of the present disclosure.

### DETAILED DESCRIPTION

Disclosed is a system for generating multi-category, multi-component payment and retention policies. Embodiments of the present disclosure can be implemented to answer questions such as how to distribute a fixed budget among multiple categories of subjects, e.g., customers, and within each category, how to distributed the fixed budget among components of payment. More particularly, embodiments of the present disclosure may be implemented to recommend a payment policy, in connection with customer retention, attrition reduction, and the like. It should be understood that the recommendation of a payment policy may include the recommendation of a change in an existing implemented policy, the recommendation of a certain policy with a range of quantitative policy parameters, etc.

According to an illustrative embodiment of the present disclosure, subjects can be categorized and a method for a recommending a payment policy takes into account category value estimates for these categories and generates multi-category policies. For example, a budget can be divided among multiple categories according to a multi-category policy. In an exemplary method for making a recommendation, e.g., increase a subject's payment 5%, the cost of losing the subject, or attrition, is considered based on a value of a category of the subject. That is, subjects of a category N may be more costly to initially obtain than subjects of a category M, and therefore may warrant an increase in payment to subjects from category N to reduce attrition, thereby reducing the higher replacement costs associated with subjects of category N.

According to an exemplary embodiment of the present disclosure, multi-category policies that are determined to be insensitive to inaccuracies in the category value estimates can be selected for implementation.

Further, according to an exemplary embodiment of the present disclosure, behavioral models of policy implementers, such as managers in charge of deciding per-subject payment, can be used to determine estimated impacts of policy recommendations.

Further still, according to an illustrative embodiment of the present disclosure, a multi-component optimization engine is used, which produces policies selected to reduce multiple attrition cost metrics, and a recommendation engine, which selects between categories of policies (such as specific and directional categories) based on a sensitivity analysis. It should be understood that payment components include, for example, performance-based components, market-based components, one-time payments, term-payments, etc. More generally, the payment components refer to the division of the budget within a category.

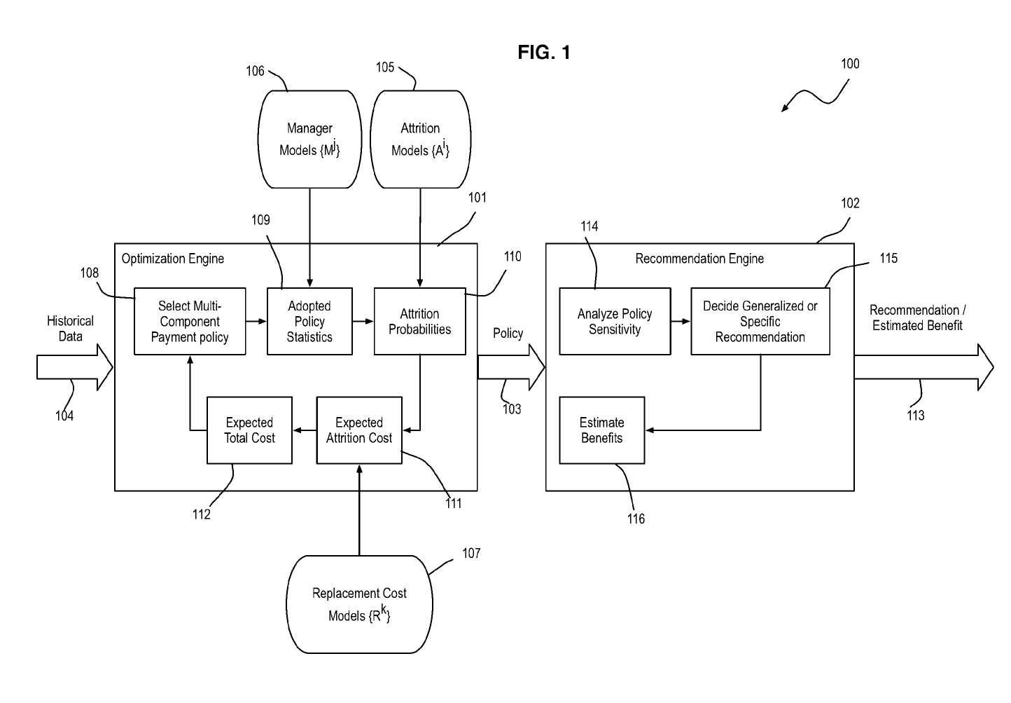

Referring now to FIG. 1, according to an illustrative embodiment of the present disclosure a system 100 includes an optimization engine 101 and a recommendation engine 102. The optimization engine 101 outputs at least one policy 103 to the recommendation engine 102, based on historical data 104. The optimization engine 101 also receives attrition models 105, manager models 106 and replacement cost models 107.

According to an illustrative embodiment of the present disclosure, the optimization engine 101 performs an iterative method to determine a recommended payment policy, on the basis of the historical data 104. The optimization engine 101 uses the attrition models 105 to determine a multi-component payment policy 108, which can potentially reduce attrition cost on the historical data 104. The term “multi-component payment policy” denotes the payments to be made to subjects, across multiple payment components, as a function of each subject's category. The term “payment policy” will be used interchangeably with “multi-component payment policy” in the remainder of this text. In some cases, the payment policy can be selected from a pre-specified set of possible policies.

The payment policy determined in 108 can be transformed into adopted policy statistics 109 by using the manager models 106. Each manager model models a per-category, per-component conditional distribution of the adopted payment policy, conditioned on the recommended payment policy. According to an exemplary embodiment, the manager models 106 are a set of per-category, per-component normally-distributed random variables, which when added to the respective recommended per-component, per-category payments, yield the statistics of the adopted policy.

The adopted policy statistics 109 can be evaluated against the attrition models 105 to generate attrition probabilities 110 for the subjects in the historical data 104. Expected attrition costs 111 are determined using the replacement cost models 107 and the attrition probabilities 110. An expected total cost 112 can be modeled on the basis of attrition, and on the basis of the expected number of subject attritions (referred to herein as the “attrition number”). In an exemplary embodiment, the expected total cost can be a linear combination of the attrition cost and the attrition number. In another exemplary embodiment, the expected total cost can be a 2-vector with components equal to attrition number and attrition cost. In another exemplary embodiment, the expected total cost function can be determined as a function of two arguments, namely: (1) The difference between the attrition number and the globally minimal attrition number, the difference normalized by the globally minimal attrition number; and (2) The difference between the attrition cost and the globally minimal attrition cost, the difference normalized by the globally minimal attrition cost. The total cost function can be the maximum of the two arguments, the linear combination of the two arguments, etc.

According to an exemplary embodiment of the present disclosure, at block 112, the total cost function can be expressed as:

min max((N−N′)/N′,(C−C′)/C′)

where N* is a minimum attrition number, and N is a attrition number for a given policy, and wherein C* is a minimum attrition cost, and C is an attrition cost for the given policy. More particularly, the minimum attrition number N* is a minimum number of subjects lost to attrition in a case where cost is not a factor, and the minimum attrition cost is C* is a minimum cost associated with losing a subject where the attrition number is not a factor. For example, the minimum attrition cost is C* can include a cost associated with replacing a subject (e.g., advertisement costs, etc.) and a difference between the cost of a lost subject and a replacement subject. A policy that minimizes both the attrition number and the attrition cost may not be feasible. The policy simultaneously controls both N and C.

In view of the foregoing, it can be seen that a current policy can be compared to a theoretical best policy achieving N* and C*. For example, it can be said that a current policy achieves 60% of the results of the theoretical best policy.

According to the total cost function above, each candidate policy can be evaluated to find a maximum of a plurality of arguments (e.g., the higher of (N−N′)/N′ or (C−C′)/C′). Here, for each candidate policy, the maximum of the two arguments can be assigned as a cost. The candidate policy having a minimum cost, as compared to the plurality of candidate policies, can be selected.

It should be understood that the attrition cost and attrition number can be replaced with other metrics. As an example, in one embodiment, the attrition number can be determined by weighting a probability of each subject's attrition, or the attrition risk, by a factor dependent on the category of subject, and summing the resultant values across all subjects.

According to an illustrative embodiment of the present disclosure, an iterative approach can be used to generate the policy 103, which is output to the recommendation engine 102. Specifically, the payment policy selector 108 can use the expected total costs 112 from previously determined policies to iteratively improve the payment policy. In an exemplary embodiment this can be done by determining a new policy as a function of the policies used in previous iterations, and their associated policy costs, by using an iterative optimization approach to minimize the expected total cost, for example, as shown in the equation above. The iterative optimization approach employed can be a gradient-descent approach or any other approach well-known in the literature.

Since the parameters of the various models can, in general, not be determined without some uncertainty, in an exemplary embodiment of the present disclosure the optimization engine 101 devises multiple payment policies 103, each of which reduces the total expected cost for a different set of parametric assumptions on the employed models. As an example, the category value estimates assigned to the various categories can be varied, and a different policy can be generated for each such variation. Multiple policies can also be generated by employing alternative sets of attrition/manager/cost models, and by using multiple total cost functions.

According to an illustrative embodiment of the present disclosure, the recommendation engine 102 transforms the policies 103 into a recommended policy, and optionally determines the expected benefits of the recommendation 113. A sensitivity analysis 114 is performed on the set of policies output by the optimization engine, to determine robustness of the recommendations. That is, the sensitivity analysis 114 determines which policy is insensitive, such that an insensitive policy returns good results for a relatively broach range of payment components and subject categories. In an exemplary embodiment, the sensitivity of a policy can be determined by evaluating the expected cost of the policy for each of multiple assumptions on parameters of the models 105, 106 and 107. As an example, the category value estimates assigned to the various categories can be varied over a pre-specified range, and the worst-case (e.g., maximum) expected cost of a policy, as well as the difference between the worst-case cost and best-case cost, can be determined over this range. In an exemplary embodiment, a desirable policy can be one for which the worst-case expected cost estimate is low since such a policy corresponds to lower attrition costs over a broad range of modeling assumptions.

According to an illustrative embodiment of the present disclosure, based on the sensitivity, the recommendation engine 102 decides, at block 115, to give generalized directional guidance (e.g., increase component X for Category Y) or specific quantitative recommendations (e.g., increase component X for Category Y by Z percent). In an exemplary embodiment, a generalized recommendation can be issued if the sensitivities of policies is large. The sensitivities of a policy can be measured, for example, as the difference between worst-case and best-case expected costs as the model parameters vary over a pre-specified range. Based on the type of recommendation, an additional quantification of expected benefits 116 can also be performed. In an exemplary embodiment, the expected benefits can be measured by estimating the reduction is attrition cost and/or attrition number on the historical data through the implementation of the recommended policy.

In view of the foregoing, in an exemplary embodiment of the present disclosure the recommendation engine 102 analyzes the sensitivity of policy recommendations to parametric assumptions on the attrition/manager/cost models, and then selects as a policy recommendation, either a specific quantitative multi-category multi-component policy, or a directional policy (e.g., increase component X for Category Y).

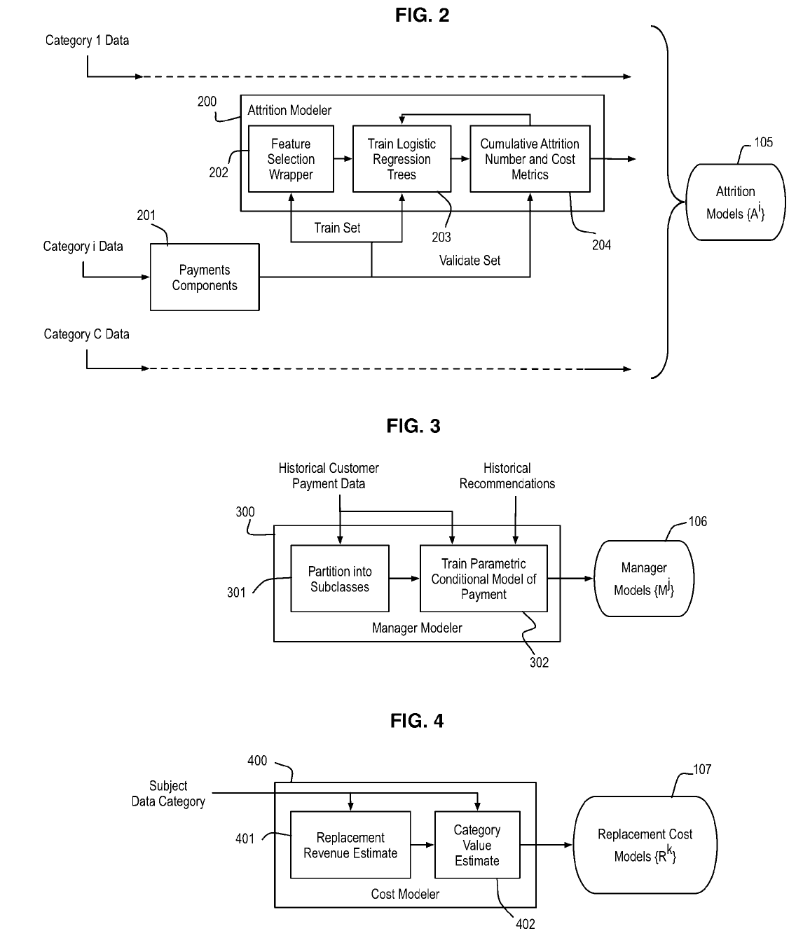

Referring now to FIG. 2, an attrition modeler 200 models a probability of attrition, or attrition risk, for each subject conditioned on customer data. The customer data can include, for example, customer location, age and other demographic information, location, years of relationship, historical value (e.g., measured through sales over the years), etc. Customer data can also include historical payment components 201 (or retention components in the case of retention implementations), as well as customer category data. In the illustrative embodiment, a separate attrition model can be generated for each customer category.

The payment components 201 may include, for example, customer rewards, discounts for customers, payments based on market conditions, and payments based on the relationship with the customer (e.g., measured through years of relationship, sales, etc.). Some of the component amounts may be directly available in the historical data. Those not directly available may need to be inferred from the data. Referring to the inference of payment components, uni-component payment categories are identified and used to learn a parametric model. The generative model is then used to model to infer components of dual-component payment categories, and so on.

For each subject category, a separate model is fit for each subject category (i.e., Category 1 through Category C in FIG. 2). In the illustrative embodiment, subsets of data features are selected from the payment components 201 using forward/backward wrappers 202 (forward/backward wrappers are well-known in the art), iteratively with model fitting. An attrition probability can be modeled by logistic regression trees at block 203. Alternative methods for modeling the attrition probability include the application of non-parametric regression, Gaussian-mixture models, other generative or discriminative models, etc. Data validation can be performed by determining statistics of total attrition numbers and costs on validation data set at block 204, and comparing to actual attrition numbers and costs. The validation and model fitting is performed iteratively within the attrition modeler 200.

In view of the foregoing, in an exemplary embodiment of the present disclosure the attrition modeler 200 infers multiple payment components from historical data, and uses logistic regression trees in an iterative feature-selection/training/validation to estimate the dependence of attrition risk or probability on the multiple payment components of the subject's payment.

Referring now to FIG. 3, in an exemplary embodiment of the present disclosure a manager modeler 300 models the payment policy adopted by managers, conditioned on subject data and conditioned on the recommended payment policy. The manager modeler 300 receives inputs including historical payment data by subject category and historical policy recommendations. At block 301, the manager modeler 300 partitions subjects into sub-categories, for example, all subjects with a given sales value may form a subcategory. Within each subcategory, the distribution of adopted payment conditioned on the recommended payment policy is modeled using a parametric Gaussian generative model at block 302. As an alternative, other generative models, or non-parametric models may be implemented. The modeling can be on a per-component basis, where a different model is generated for each different payment component. Here, the manager models can be a set of per-category, per-component normally-distributed random variables, which when added to the respective recommended per-component, per-category payments, yield the statistics of the adopted policy.

In view of the foregoing, in an exemplary embodiment of the present disclosure the manager modeler 300 determines a behavioral model of the policy implementers, linking policy recommendations to actual policy implementations. The manager modeler 300 is based on historical recommendations and policy implementations, such as payment/retention payouts.

Referring now to FIG. 4, in an exemplary embodiment of the present disclosure a cost modeler 400 estimates the attrition costs which would result from attrition of a specific subject. In an illustrative embodiment, the cost of attrition is determined by determining a revenue replacement cost 401. This can include a fixed revenue cost of attrition, based on determination of fixed marketing costs needed to obtain a replacement, and a variable revenue cost modeled by modeling the difference of sales between the attritioned customer and the replacement customer. At block 402 the revenue replacement cost can be modified by a category-based replacement factor, which models a value of subject beyond the fixed and variable replacement costs. In an illustrative embodiment, a category value factor can be determined for each category, and the replacement revenue cost for each subject in a category can be multiplied by the associated category value factor.

For customers, the replacement cost can be determined as a function of historical customer value/trend data. For example, customers with higher current strength-of-relationship (measured, for example by the years of relationship, number/value of sales, etc.) can have higher value than customers with lower current strength-of-relationship. In another example, customers who may be expected to increase sales in future (e.g., based on historical trend data, for example) can have higher value than customers not expected to increase sales in future.

The values of subjects may be given as relative values, absolute values, positives, negatives, etc. That is, according to an exemplary embodiment of the present disclosure, the values may take any form that would allow one of ordinary skill in the art to distinguish between polices. The values are not to be limited to specific examples given herein.

In view of the foregoing, the cost modeler 400 models, for each of multiple categories of subjects, a category-dependent cost of attrition, using parameterized models.

Referring again to FIG. 1, the subject data may include C Categories. Categories can be based on features including performance, strength-of-relationship, etc. More generally, subject data may include, but is not limited to, historical payment data (absolute and increase), sales data for customers, location, attrition/non-attrition indicator, historical value, years of relationship, etc.

While exemplary embodiments have been described above in terms of customer retention, it should be understood that embodiments of the present disclosure are not limited thereto. For example, in another exemplary embodiment, a payment policy can be generated to recommend a fair market-based payment to a first party in an economic relationship with a second party over time. In this example the payment policy can be determined based on a replacement cost of the first party, wherein the replacement cost can be determined as a function of historical performance data of the first party. Here, the historical performance data can translate to a value. That is, the value can be measured based on the historical performance data using, for example, direct metrics such as transactions closed, sales, etc., or by indirect metrics such as work product generated, project contributions, etc. In view of the foregoing, the present disclosure is not to be limited to any particular embodiment.

By way of recapitulation, according to an embodiment of the present disclosure, a method of generating a recommendation reducing a cost of subject attrition can include generating a plurality of policies (108), wherein each of the plurality of policies models a dependence of an attrition risk of each of a plurality of subject categories on a plurality of payment components of the plurality of subject categories, and each of the plurality of policies is associated with a respective set of weights on the plurality of subject categories, determining a benefit of each of the plurality of policies (112), selecting a selected policy from among the plurality of policies according to the benefit (103), and generating a recommendation for adjusting a specific payment component of a specific subject for each policy according to the selected policy (113).

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

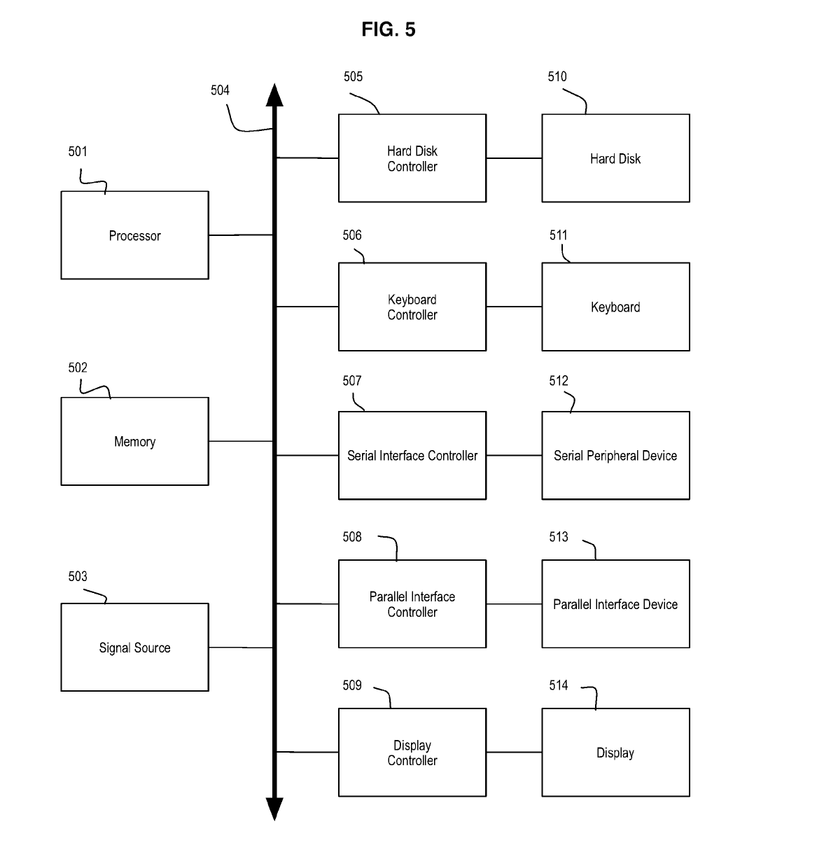

For example, FIG. 5 is a block diagram depicting an exemplary computer system for determining a payment policy according to an embodiment of the present disclosure. The computer system shown in FIG. 5 includes a processor 501, memory 502, signal source 503, system bus 504, Hard Drive (HD) controller 505, keyboard controller 506, serial interface controller 507, parallel interface controller 508, display controller 509, hard disk 510, keyboard 511, serial peripheral device 512, parallel peripheral device 513, and display 514.

In these components, the processor 501, memory 502, signal source 503, HD controller 505, keyboard controller 506, serial interface controller 507, parallel interface controller 508, display controller 509 are connected to the system bus 504. The hard disk 510 is connected to the HD controller 505. The keyboard 511 is connected to the keyboard controller 506. The serial peripheral device 512 is connected to the serial interface controller 507. The parallel peripheral device 513 is connected to the parallel interface controller 508. The display 514 is connected to the display controller 509.

In different applications, some of the components shown in FIG. 5 can be omitted. The whole system shown in FIG. 5 is controlled by computer readable instructions, which are generally stored in the hard disk 510, EPROM or other non-volatile storage such as software. The software can be downloaded from a network (not shown in the figures), stored in the hard disk 510. Alternatively, a software downloaded from a network can be loaded into the memory 502 and executed by the processor 501 so as to complete the function determined by the software.

The processor 501 may be configured to perform one or more methodologies described in the present disclosure, illustrative embodiments of which are shown in the above figures and described herein. Embodiments of the present disclosure can be implemented as a routine that is stored in memory 502 and executed by the processor 501 to process the signal from the signal source 503. As such, the computer system is a general-purpose computer system that becomes a specific purpose computer system when executing the routine of the present disclosure.

Although the computer system described in FIG. 5 can support methods according to the present disclosure, this system is only one example of a computer system. Those skilled of the art should understand that other computer system designs can be used to implement the present invention.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In a non-limiting example, the modules include an optimization module (FIG. 1: 101), which generates policies based on historical data and a plurality of models, a recommendation module (FIG. 1: 102), which receives the policies and outputs a recommendation and an estimated benefit. The method steps can then be carried out using the distinct software modules of the system, as described above, executing on one or more hardware processors (e.g., processor 501, and the like). Further, a computer program product can include a tangible computer-readable recordable storage medium with code adapted to be executed to carry out one or more method steps described herein, including the provision of the system with the distinct software modules.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A method of generating a recommendation reducing a cost of subject attrition comprising:
generating a plurality of policies, wherein each of said plurality of policies models a dependence of an attrition risk of each of a plurality of subject categories on a plurality of payment components of said plurality of subject categories, and each of said plurality of policies is associated with a respective set of weights on said plurality of subject categories;
determining a benefit of each of said plurality of policies;
selecting a selected policy from among said plurality of policies according to said benefit; and
generating a recommendation for adjusting a specific payment component of a specific subject for each policy according to said selected policy.

2. The method of claim 1, further comprising determining an estimate of a benefit of said recommendation.

3. The method of claim 1, wherein generating said plurality of policies further comprises:
receiving a plurality of attrition models;
receiving a plurality of manager models; and
receiving a plurality of subject replacement cost models.

4. The method of claim 3, further comprising generating said plurality of attrition models.

5. The method of claim 4, further comprising:
receiving historic data for said plurality of subject categories;
determining a payment component for each of said plurality of subject categories;
determining for each of said plurality of subject categories, said attrition risk conditioned on said payment components; and
outputting for each of said plurality of subject categories, said attrition risk as a corresponding attrition model of said plurality of attrition models.

6. The method of claim 3, further comprising generating said plurality of manager models.

7. The method of claim 6, further comprising:
receiving historic payment data for said plurality of subject categories;
receiving a plurality of historic policy recommendations;
determining a plurality of payment components for each of said plurality of subject categories;
modeling a distribution of an adopted payment to each of said plurality of subject categories conditioned on a policy recommendation of said historic policy recommendations ; and
outputting said distribution as a manager model of said plurality of manager models.

8. The method of claim 3, further comprising generating said plurality of subject replacement cost models, wherein each subject replacement cost model estimates an attrition cost corresponding to attrition of a specific subject for each of a plurality of subject categories.

9. The method of claim 1, wherein said benefit of each of said plurality of policies is evaluated by a total cost function, wherein said selecting is performed according to said total cost function.

10. The method of claim 1, further comprising:
determining a sensitivity of each of said plurality of policies; and
selecting said selected policy from among said plurality of policies according to said benefit and said sensitivity.
